(19) United States
(12) Patent Application Publication
(10) Pub. No.: US 2009/0002567 A1
(43) Pub. Date: Jan. 1, 2009

(54) IMAGE ANALYSIS APPARATUS AND IMAGE ANALYSIS METHOD

(75) Inventors: Emi Maruyama, Tokyo (JP); Kazuhiro Nakamura, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/163,890

(22) Filed: Jun. 27, 2008

(30) Foreign Application Priority Data
Jun. 29, 2007 (JP) 2007-171795

(51) Int. Cl. H04N 5/14

(52) U.S. Cl. 348/700; 348/E05.062

(57) ABSTRACT

An image analysis apparatus and an image analysis method are provided with functions of easily comparing an image with a scene change point list and easily correcting scene change points. The image analysis apparatus includes a scene change information storage unit for storing information of scene change points detected by a scene change detection unit, an image data playback unit for playing back image data stored in an image data storage unit, a controller for controlling a support operation for confirmation of scene change points of the image analysis apparatus, an operation input unit for inputting operation information to the controller, and a display unit. When the information of the frame being played back of a played back image passes the information of the scene change point, a scene change is warned on the display unit.

### CROSS-REFERENCE TO RELATED APPLICATIONS

This application claims the benefit of priority of Japanese Patent Application No. 2007-171795, filed Jun. 29, 2007, the entire contents of which are incorporated herein by reference.

### BACKGROUND

1. Field

The present invention relates to an image analysis apparatus and an image analysis method according to detection of a scene change point as a type of image feature and image content analysis.

2. Description of the Related Art

When non-compression digital image data is subjected to compression coding to GOP (group of pictures) composed of I picture (intra coded picture), B picture (bi-directionally predictive coded picture), and P picture (predictive coded picture) by a method of MPEG (moving image experts group) and the like and stored to a storage medium such as a magneto-optical disc (MO disc), DVD (Digital Versatile Disc), HD DVD (High-Definition Digital Versatile Disc), and the like or transmitted through a communication line, it is necessary to make the data amount (bit amount) of the compression image data after the compression coding equal to or less than the storage capacity of the storage medium or the transmission capacity of the communication line while keeping the quality of an image after it is decoded.

The compression coding processing of the non-compression digital image data employs a hybrid system including discrete cosine transform processing and reducing redundancy in a time axis direction making use of the correlation between frames without depending on the MPEG1 or MPEG2 standards and the like.

The discrete cosine transform processing is orthogonal conversion which converts an input sampled value to an orthogonal component such as a space frequency component and the like. With this operation, spatial correlation components can be reduced.

In the inter-frame compression, the data amount (bit amount) of the compression image data after the compression coding is further reduced by determining the difference between a preceding frame and a succeeding frame and coding the value of difference (prediction error) making use of a property that ordinary images resemble well in the preceding and succeeding frames. In particular, motion compensated inter-frame prediction method, which reduces a prediction error by determining an inter-frame difference by predicting the motion of an image, is effective.

In the hybrid system prediction coding, which only codes the difference data between the image data of a predetermined frame and the reference image data of the frames preceding and succeeding the predetermined frame which is subjected to the discrete cosine transform processing, is employed in addition to the intra-frame coding of applying the image data of the predetermined frame to the discrete cosine transform processing as it is and then coding the data.

A prediction coding method includes forward prediction coding of determining a prediction error by motion-compensation for reference image data located forward in time, backward prediction coding of determining a prediction error by motion-compensation for reference image data located backward in time, and bidirectional prediction coding using either one of reference image data located forward or reference image data located backward or both of the reference image data.

A reference frame is necessary in order to decode the frame coded by an inter-frame compression mode. That is, an original frame cannot be restored only by a frame coded by the inter-frame compression. In contrast, since the frame coded by the intra-frame compression (hereinafter, called “I picture”) is coded only by the information in a frame, it can be restored only from I picture.

In the MPEG standard, an inter-frame coded frame (hereinafter, called “P picture”) is obtained by the forward prediction coding using the I picture. Note that the P picture can be also obtained by applying a preceding P picture to the forward prediction coding. Further, a bidirectional prediction adaptation switching frame (hereinafter, called “B image”) is obtained by bidirectional prediction coding using either preceding or succeeding I picture and P picture in the same direction or the pictures in the different direction.

When non-compression digital image data is subjected to compression coding, the non-compression digital image data may be subjected to preprocessing or to image feature and image content analysis in some cases.

An object of the preprocessing is to reduce image noise, which is unintentionally superimposed by photographing due to the shooting environment, and to reduce image noises due to deterioration of a film to thereby reduce the amount of information of the image noise in the non-compression digital image data before compression coding is performed. The preprocessing includes, for example, a low-pass filter.

The feature analysis and content analysis of image improve a coding efficiency by, for example, analyzing the correlation of the non-compression digital image data and regarding a group of frames having a high correlation as one scene.

Around a scene change point at which a scene change occurs, an image frame just preceding the scene change point, need not be subjected to prediction coding using a frame just succeeding the scene change point, and a frame just succeeding the scene change point need not be subjected to prediction coding using a frame just preceding the scene change point. If the prediction coding is performed across the scene change point, since prediction is performed between frames having a low correlation, it is liable that the coding efficiency is deteriorated and further image quality is deteriorated because image distortion is caused in the vicinity of the scene change point after the image is compressed.

Further, in the compression coding processing of the non-compression digital image data, since a concordance between a scene change point and a boundary of GOP contributes to improved quality of an image after compression coding and increased efficiency of compression, it is important to detect scene change points of the digital image data and to create a list thereof. By reflecting scene change points to the compression coding processing, it becomes possible for an encoder to anticipate frames having no correlation so that the prediction coding can be more appropriately performed and distortion due to the compression coding can be reduced.

Accordingly, when an image including a plurality of scenes is subjected to the compression coding of the non-compression digital image data, prediction coding should not be performed across the scene change point.

As a method of detecting a scene change point, there is known a method of determining a data difference for each pixel between two continuous frames and determining that a scene change occurs when a total of the absolute values of the differences exceeds a predetermined threshold as disclosed in, for example, JP-A 07-111631.

Further, in a detection method disclosed in JP-A 07-193818, a scene change point is detected by predicting the motion of an image, determining the sum of the absolute values of the prediction errors in each frame, and comparing an average value, which has been determined by averaging the sum of the absolute values of the prediction errors in respective frames, with the sum of the absolute values of the prediction errors in the respective frame.

In conventional scene change detection methods as described above, a scene change point may be erroneously detected, for example (1) when an image in a frame has a large amount of changes as in shooting and bombing scenes, (2) when a same frame continues in slow motion processing after shooting, and (3) when a parameter such as luminance and the like for measuring the amount of image change changes little. Accordingly, in such conventional methods for detection of scene change points, it is difficult to avoid erroneous detection. Thus, in order to detect a correct scene change, it has been indispensable for an operator to compare an image at a certain scene change point with the preceding image after detection of the scene change point and appropriately correct the scene change point. As a result, there has been a problem that the confirmation of a scene change point for correcting the scene change point, and an operation required after the scene change point has been erroneously detected, are very troublesome to the operator.

### SUMMARY OF THE INVENTION

To solve the above problems, an object of the present invention is to provide an image analysis apparatus and an image analysis method which are provided with functions of easily comparing an image with a scene change point list and easily correcting the scene change point.

According to the present invention for solving the above object, there is provided an image analysis apparatus which includes a storage unit adapted to store scene change points included in image data as a scene change point information list, a display unit adapted to display frames based on the image data, and the scene change point information list stored in the storage unit, a determination unit for determining, when the image data is played back, whether or not a frame in the image data displayed on the display unit passes a scene change point included in the scene change point information list, and a notification unit adapted to notify that a scene change occurs on the display unit when the determination unit determines that the displayed frame passes the scene change point included in the scene change point information list.

Further, the present invention is provided an image analysis method of detecting a scene change in an image data and creating a scene change point information list for the image data, in which the image analysis method includes playing back image data to display frames for detecting a scene change, determining whether or not the displayed frame passes the scene change point included in the scene change point information list, and notifying that a scene change point occurs when the displayed frame passes the scene change point included in the scene change point information list.

For the purpose of the present invention of comparing an image (or a (motion) picture) comprising a succession of at least 24 frames per second with scene change points, the exactness of agreement in time between a displayed frame and a scene change point is not absolutely required. Accordingly, the phrase of “a displayed frame passes a scene change point” can include any of cases where the displayed frame is going to pass, is passing, and has just passed the scene change point.

According to the present invention, a scene change point can be easily compared with an image, i.e., a succession of frames, prior to the compression coding of the image data, thereby the scene change point can be easily corrected.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing an outline of an embodiment of an image analysis apparatus according to the present invention;

FIG. 2 is a conceptual view showing an example of an operation input unit and a display unit of the embodiment of the image analysis according to the present invention;

FIG. 3 is a flowchart of scene change point information list creation processing when a scene change point information list is created by detecting a scene change point from image data in the embodiment of the image analysis method according to the present invention;

FIG. 4 is a flowchart of the scene change point information list confirmation processing when the scene change point is confirmed using the scene change point information list which is obtained by detecting the scene change of the image data in the embodiment of the image analysis method according to the present invention; and

FIG. 5 is a flowchart of scene change point information list edit processing when the scene change point is edited using the scene change point information list which is obtained by detecting the scene change of the image data in the embodiment of the image analysis method according to the present invention.

### DETAILED DESCRIPTION

An embodiment of an image analysis apparatus and an image analysis method according to the present invention will be explained with reference to accompanying drawings.

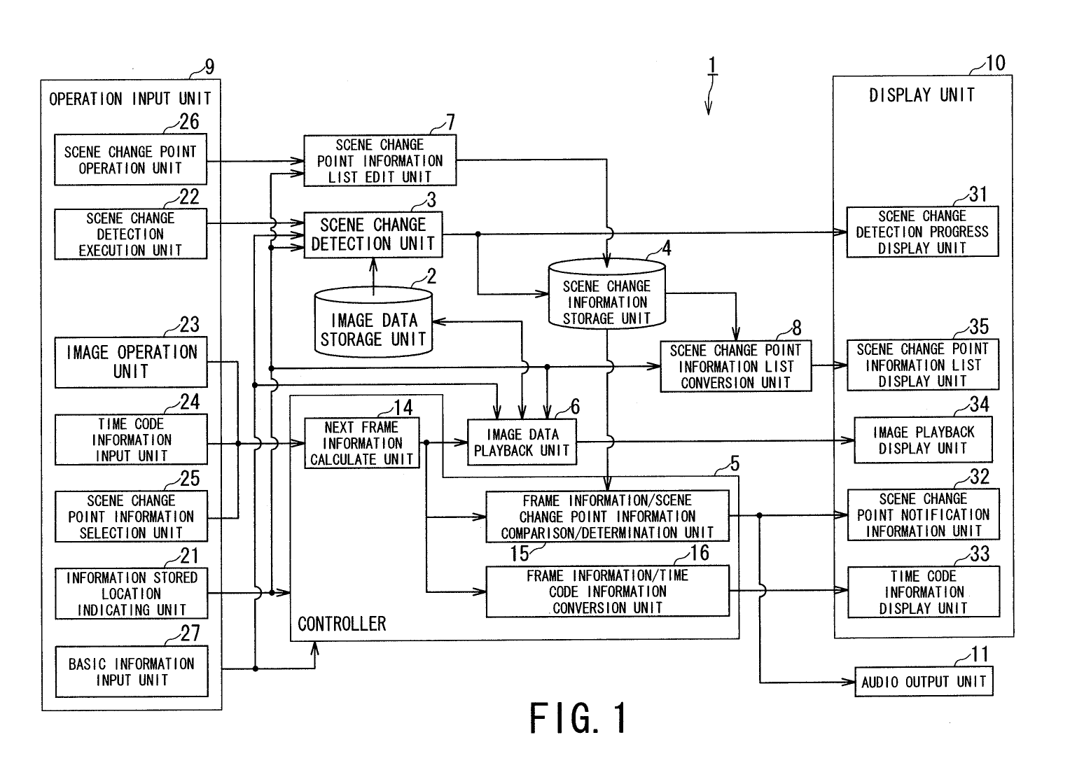

FIG. 1 is a block diagram showing an outline of the image analysis apparatus of the embodiment.

As shown in FIG. 1, the image analysis apparatus 1 includes an image data storage unit 2 for storing image data, a scene change detection unit 3 for detecting scene change points by analyzing (feature analysis, content analysis) the image data stored in the image data storage unit 2, a scene change information storage unit 4 (storage unit) for storing the scene change point information detected by the scene change detection unit 3, a controller 5 for controlling a support operation for confirmation of scene change points of the image analysis apparatus 1, an image data playback unit 6 for playing back the image data stored in the image data storage unit 2, a scene change point information list edit unit 7 for editing the scene change point information stored in the scene change information storage unit 4, a scene change point information list conversion unit 8 for converting the scene change point information stored in the scene change information storage unit 4 into a scene change point information list, an operation input unit 9 for inputting operation information to the scene change detection unit 3, the controller 5, and the scene change point information list edit unit 7, a display unit 10, and an audio output unit 11.

Herein, a scene change point means a point at which a scene in an image(i.e., a succession of frames) changes and which is indicated by the detection performed by the scene change detection unit 3 and the editing performed by the scene change point information list edit unit 7. When a plurality of scene changes exist in an image, scene change points exist corresponding to the respective scenes.

The image data storage unit 2 outputs the image data stored therein in response to an image output request from the scene change detection unit 3 or the image data playback unit 6. A magnetic disc storage device, such as HDD, and FD, a magnetic tape storage device, or a semiconductor memory storage device may, for example, be used as the image data storage unit 2.

An image to be subjected to compression coding is digital data and may be called an original image or picture because it is an image or picture before it is subjected to compression. Although the image data has various formats depending on an encoder used for compression coding processing, a frame is composed by disposing pixel data in a commonly determined sequence. For example, MPEG2 employs a 4:2:0 format in which each of luminance data and color difference data as the original image has an 8-bit width as well as the color difference data is thinned out ½ to the luminance data in a horizontal direction and a vertical direction. Further, in, for example, MPEG4 AVC, the width of pixel data is permitted from 8 bits to 12 bits. In case that the pixel data includes luminance data and color difference data, it also corresponds to a 4:4:4 format and a 4:2:2 format, in which the color difference data is thinned out ½ only in a horizontal direction, in addition to the 4:2:0 format. For example, two hours movie has 172,800 frames (2×60 minutes×60 seconds×24 frames) whose frame consists of the above image data.

The scene change detection unit 3 detects scene change points from the image data file stored in the image data storage unit 2 according to the operation information input from the operation input unit 9 while searching the image data file stored in the image data storage unit 2 and stores a scene change point information list file in the scene change information storage unit 4 (operation for detecting the scene change point). The scene change detection unit 3 analyzes the correlation between frames and detects a scene change point, at which the correlation is greatly changed. When the scene change point is detected, the scene change detection unit 3 outputs the frame information (scene change point information) of the frame of the scene change point to the scene change information storage unit 4. For example, a method of determining the change of luminance (in an RGB format, luminance calculated from respective R, G, B components) between continuous or adjacent frames by statistical processing and assuming that a scene change occurs when the amount of change of the luminance is larger than a threshold value, and the like are known as a method of detecting the scene change (refer to JP-A 07-111631 and JP-A 07-193818). Accordingly, the scene change detection unit 3 includes an accumulation unit for accumulating an image of at least one frame to an input image.

Here, the frame information shows a frame number which is a continuous number from a leading frame of the image data, although a frame number is not added to the image data as long as a dedicated header is not included therein. However, since the size of the image data per one frame is uniquely determined from resolution and a format (4:2:0 and 4:4:4, and the like described above), it is possible to determine the number of the present frame from (number of present frame=(present address−leading address)÷size per one frame). In contrast, it is possible to determine a present address by (present address=frame number×size per one frame+leading address). In the following explanation, even if the dedicated header is not included in the image data, it is called frame information included in the image data or frame information of the image data.

The scene change information storage unit 4 sequentially stores the scene change point information which the scene change detection unit 3 input thereto. The stored scene change point information is stored making use of a format which can use all the input scene change point information as database. That is, all the scene change point information of the image is stored to the scene change information storage unit 4 as the scene change point information list.

The controller 5 controls the image data playback unit 6, the scene change information storage unit 4, the display unit 10, and the audio output unit 11 according to the operation information input from the operation input unit 9, compares and determines the frame played back by the image data playback unit 6 and the scene change point information list stored in the scene change information storage unit 4 (determination unit), causes the display unit 10 to display scene change point notification information and causes the audio output unit 11 to output a scene change point notification sound (audio signal) when the frame to be played back passes the scene change point (support for confirmation operation of scene change point).

Whether or not a frame in the image data to be played back on the display unit 10 passes through a scene change point is determined by comparing the frame information of the frame with scene change points included in the scene change point information list (frame information). That is, when the frame information of the frame is compared with the scene change point information included in the scene change point information list and the scene change point information, by which (frame information of a frame in the image data to be played back)≧(scene change point information) is established, is included in the scene change point information list, it is determined that the frame has passed through a scene change point. As a result, even if the frame information of the frame being displayed does not agree with the scene change point information included in the scene change point information list, when the number of the frame is larger than an arbitrary scene change point included in the scene change point information list, it is possible to determine whether or not the frame has passed through the scene change point. That is, the frame can be compared and determined while not playing every frame but playing every arbitrary number of frames. When image data is inversely played back from an end frame to a start frame, whether or not a frame in the image data to be inversely played back on the display unit 10 has passed through the scene change point can be determined by determining whether or not (frame information of a frame in the image data to be played back)≦(scene change point information) is satisfied.

The controller 5 includes a next frame information calculate unit 14 for adding or subtracting the frame information of a frame in the image data to be displayed next on the display unit 10 according to a playback operation input (frame information or time code information) from the operation input unit 9 and outputs the determined result to the image data playback unit 6, a frame information/scene change point information comparison/determination unit 15 for comparing and determining whether or not the next frame calculated by the next frame information calculate unit 14 has passed through a scene change point included in the scene change point information list stored in the scene change information storage unit 4 and outputs the result of comparison and determination to the display unit 10, and a frame information/time code information conversion unit 16 for converting the frame information of the next frame calculated by the next frame information calculate unit 14 into time code information and outputs it to the display unit 10.

The image data playback unit 6 obtains the one frame in the image data, which is stored in the image data storage unit 2, based on the frame information output from the controller 5 and outputs it to the display unit 10. That is, a frame in the image data, which is played back by the image data playback unit 6, need not be played back every frame and may be played back at desired frame intervals. When, for example, the frame information output from the controller 5 is information for “jumping to a frame N frames before”, the image data playback -unit 6 calculates the size corresponding to the N frames, determines an address by subtracting the size corresponding to the N frames from the address of the frame being displayed on the display unit 10, and obtains the image data of one frame existing in the address.

The scene change point information list edit unit 7 performs editing comprising at least one of adding, deleting and changing the scene change point information stored in the scene change information storage unit 4 according to the operation information input from the operation input unit 9. (edit operation of scene change point).

The scene change point information list conversion unit 8 converts all the scene change point information stored in the scene change information storage unit 4 as frame information to time code information, creates the scene change point information list and outputs it to the display unit 10.

Herein, the scene change detection unit 3, the controller 5, the image data playback unit 6, the scene change point information list edit unit 7, and the scene change point information list conversion unit 8 include CPU (Central Processing Unit), ROM (Read Only Memory), a RAM (Random Access Memory), and the like. The CPU executes various types of processing according to a program stored in the ROM or various types of application programs loaded on the RAM as well as integrally controls the image analysis apparatus 1 by creating various control signals and supplying them to the respective units. The RAM appropriately stores the data and the like which are necessary for the CPU to execute the various types of processing.

In the operation input unit 9, an operator inputs operation information to the controller 5 from input devices such as a mouse, a keyboard, a touch panel, and the like.

The operation input unit 9 includes an information stored location indicating unit 21 for indicating the locations, in which the image data file and the scene change information list are stored, to the scene change detection unit 3, the controller 5, the image data playback unit 6, the scene change point information list edit unit 7, and the scene change point information list conversion unit 8, a scene change detection execution unit 22 for causing the scene change detection unit 3 to start a scene change point detecting operation, an image operation unit 23 for outputting a playback operation (the frame information or the time code information) to the controller 5, a time code information input unit 24 for accepting desired time code information and inputting it to the controller 5, a scene change point information selection unit 25 for inputting the time code information of arbitrary scene change point information desirably selected from the scene change point information list being displayed on the displaying unit 10 to the controller 5, a scene change point operation unit 26 for outputting an edit operation information comprising at least one of adding, deleting and changing the scene change point information stored in the scene change information storage unit 4 to the scene change point information list edit unit 7, and a basic information input unit 27 for inputting the basic information of the image data.

The display unit 10 includes a scene change detection progress display unit 31 for displaying the progress of the detection when the scene change detection unit 3 detects the scene change point, a scene change point notification information unit 32(notification unit) for displaying the scene change point notification information signal when the frame information of a frame in the image data displayed on the displaying unit 10 by the image data playback unit 6, has passed through a scene change point included in the scene change point information list stored in the scene change information storage unit 4, a time code information display unit 33 for displaying the time code information of the frame in the image data displayed on the display unit 10 by the image data playback unit 6, an image playback display unit 34 for displaying the frame in the image data output from the image data playback unit 6, and a scene change point information list display unit 35, which displays the scene change point information list output from the scene change point information list conversion unit 8.

The audio output unit 11(notification unit) outputs a scene change point notification sound in response to an audio signal output request from the controller 5.

Herein , the scene change point notification for notifying that the frame information of a frame, which is being displayed on the display unit 10 of the image analysis apparatus 1 in the embodiment, has passed through the scene change point included in the scene change point information list stored in the scene change information storage unit 4, may notify to a tactile organ and other sensitive organs (smell organ, taste organ) by a device generating a vibration to an operator, a device for generating an electric pulse, and the like in addition to scene change point notification information as visual information and the scene change point notification sound as hearing information.

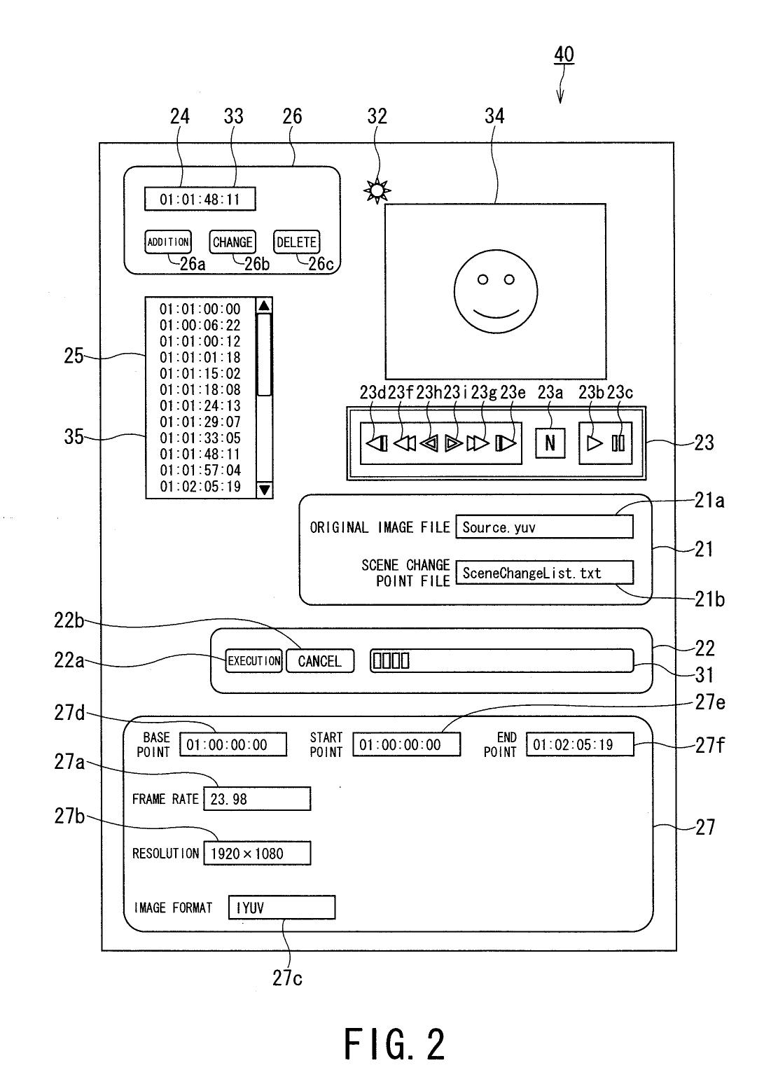

FIG. 2 is a conceptual view showing a software application example of the operation input unit 9 and the display unit 10 of the image analysis apparatus 1 in the embodiment.

As shown in FIG. 2, a screen 40 displays the information stored location indicating unit 21, the scene change detection execution unit 22, the image operation unit 23, the time code information input unit 24, the scene change point information selection unit 25, the scene change point operation unit 26, and the basic information input unit 27. The operation information, which is operated and input on the display of the screen 40, is input from the operation input unit 9 to the controller 5.

Further, as shown in FIG. 2, the screen 40 displays the scene change detection progress display unit 31, the scene change point notification information unit 32, the time code information display unit 33, the image playback display unit 34, and the scene change point information list display unit 35.

The information stored location indicating unit 21 indicates the locations in which the image data file and the scene change information list are stored to the scene change detection unit 3, the controller 5, the image data playback unit 6, the scene change point information list edit unit 7, and the scene change point information list conversion unit 8. The information stored location indicating unit 21 includes an image data file stored location indicating unit 21a for indicating the location in which the image data file on the image data file storage unit 2 is stored, and a scene change information list stored location indicating unit 21b for indicating the location in which the scene change information list on the scene change information storage unit 4 is stored.

The scene change detection execution unit 22 includes a scene change detection start unit 22a for causing the scene change detection unit 3 to start a scene change point detecting operation, and a scene change detect cancellation unit 22b for causing the scene change detection unit 3 to stop or to interrupt the scene change point detecting operation. Further, the scene change detection progress display unit 31 is displayed together to which shows how the scene change point detecting operation progresses while it is performed by the scene change detection unit 3.

The image operation unit 23 outputs the playback operation to the controller 5. The image operation unit 23 includes a jump frame number input unit 23a, a playback operation unit 23b, a pause operation unit 23c, a preceding scene jump operation unit 23d, a succeeding scene jump operation unit 23e, a preceding frames jump operation unit 23f, a succeeding frames jump operation unit 23g, a preceding frame jump operation unit 23h, a succeeding frame jump operation unit 23i.

The display intervals (number of frames) of the image, which are displayed on the image playback display unit 34 in the playback operation and in the jump operation, are desirably input to the jump frame number input unit 23a.

The playback operation unit 23b causes the image playback display unit 34 to play back the image every indicated frames in the jump frame number input unit 23a.

The pause operation unit 23c causes the image playback display unit 34 to pause the image being displayed.

The preceding scene jump operation unit 23d causes the image playback display unit 34 to jump from the frame being displayed to the nearest scene change point just preceding it.

The succeeding scene jump operation unit 23e causes the image playback display unit 34 to jump from the frame being displayed to the nearest scene change point just succeeding to it.

The preceding frames jump operation unit 23f causes the image playback display unit 34 to jump backward by the number indicated in the jump frame number input unit 23a from the frame being displayed.

The succeeding frames jump operation unit 23g causes the image playback display unit 34 to jump forward by the number indicated in the jump frame number input unit 23a from the frame being displayed.

The preceding frame jump operation unit 23h causes the image playback display unit 34 to jump backward from the frame being displayed to the frame by one frame.

The succeeding frame jump operation unit 23i causes the image playback display unit 34 to jump forward from the frame being displayed to the frame by one frame.

While the play back being performed, the preceding scene jump operation unit 23d, the succeeding scene jump operation unit 23e, the preceding frames jump operation unit 23f, the succeeding frames jump operation unit 23g, the preceding frame jump operation unit 23h, the succeeding frame jump operation unit 23i are disabled and enabled after they are paused by the pause operation unit 23c.

Herein, the playback operation unit 23b, the pause operation unit 23c, the preceding frames jump operation unit 23f, the succeeding frames jump operation unit 23g, the preceding frame jump operation unit 23h, and the succeeding frame jump operation unit 23i output the frame information as playback operation information, and the preceding scene jump operation unit 23d and the succeeding scene jump operation unit 23e output the time code information as the playback operation information.

The time code information input unit 24 accepts desired time code information and inputs it to the controller 5. Further, the time code information input unit 24 and the time code information display unit 33 uses the same unit. While the image is being played back on the image playback display unit 34, the time code information corresponding to a frame in the image data being played back is displayed, and when the playback of the image is stopped (paused), the input operation of the time code information is received.

The scene change point information selection unit 25 inputs the time code information of arbitrary scene change point information desirably selected from the scene change point information list being displayed to the controller 5. Further, the scene change point information selection unit 25 and the scene change point information list display unit 35 uses the same unit. While the image is being played back on the image playback display unit 34, the scene change point information of the scene including a frame in the image data being played back is displayed emphatically, whereas when the playback of the image is stopped (paused), arbitrary scene change point information is desirably selected from the scene change point information list, and displayed emphatically by input operation.

The scene change point operation unit 26 outputs an edit operation comprising at least one of adding, deleting and changing the scene change point information stored in the scene change information storage unit 4 to the scene change point information list edit unit 7. The scene change point operation unit 26 includes a change operation unit 26b for changing a scene change point information emphatically displayed in the scene change point information selection unit 25, a delete operation unit 26c for deleting the scene change point information emphatically displayed in the scene change point information selection unit 25, and an addition operation unit 26a for adding the scene change point information to the scene change point information selection unit 25. Further, the time code information input unit 24 indicates desired time code information which is input when a change operation or an addition operation is performed to the scene change point information selection unit 25.

The basic information input unit 27 inputs the frame rate information, the resolution information and the image format information, which are the basic information of the image data stored in the image data storage unit 2, the origin of the image data, and the time code information of the start point and the end point of the scene change point detecting operation to the scene change detection unit 3, the controller 5, and the image data playback unit 6. The basic information input unit 27 includes a frame rate input unit 27a for inputting the frame rate information of the image data, a resolution input unit 27b for inputting the resolution information of the image data, an image format input unit 27c for inputting the format information of the image data, a origin input unit 27d for indicating the time code information of the origin in the image data, a scene change point detection start point input unit 27e for indicating the time code information of the start point of the scene change point detecting operation, and a scene change point detection end point input unit 27f for indicating the time code information of the end point of the scene change point detecting operation. The time code information of the origin in the image data, the start point and the end point of the scene change point detecting operation, and the frame rate information are used in frame to time code conversion or time code to frame conversion. The resolution and the image format of the image data are used to derive the frame information from the address value of the image data or to derive the address value from the frame information.

The frame rate means the number of frames per one second included in the image data. The image called, for example, an NTSC interlace image has the frame rate of 30*1000/1001=29.97 Hz, and a movie material has the frame rate of 24*1000/1001=23.98 Hz. The resolution information shows the number of pixels per one frame included in the image data. The time code information is a format of HH:MM:SS:FF (HH=hour, MM=minute, SS=second, and FF=the number of frames) and is a value showing a time. In a time code system called a non-drop system, when the frame rate is 29.97 Hz, the FF shows a 30 system counter from 0 to 29, and when the frame rate is 23.98 Hz, the FF shows a 24 system counter from 0 to 23.

Further, the origin in the image data shows the leading frame of the image data and exists separately from the point from which detection of scene change points is started. Scene change points can be detected in an arbitrary segment of the image data by individually setting the origin and the start and end points of the scene change point detecting operation.

The scene change detection progress display unit 31 displays the progress while the scene change point detecting operation is being executed by the scene change detection unit 3.

The scene change point notification information unit 32 displays the scene change point notification information signal when the frame information of a frame in the image data displayed on the image data playback unit 6 has passed through a scene change point included in the scene change point information list stored in the scene change information storage unit 4. The scene change point notification information unit 32 notifies occurrence of a scene change point by an optical means, for example, blinking of an icon-like symbol mark, display of a pop-up message, and the like.

The time code information display unit 33 displays the time code information of a frame in the image data displayed on the image data playback unit 6.

The image playback display unit 34 displays a frame in the image data played back on the image data playback unit 6.

The scene change point information list display unit 35 displays the scene change point information stored in the scene change information storage unit 4 as a list. Further, just preceding scene change point information is displayed emphatically on the scene change point information list display unit 35 from the frame being displayed on the image playback display unit 34.

According to the image analysis apparatus 1 of the embodiment, scene change points can be easily compared with an image prior to the compression coding of the image data. Further, an editing work such as adding a desired scene change point, deleting an unnecessary scene change point, changing an existing scene change point, and the like can be performed easily while easily comparing scene change points with an image. That is, it is possible to cause the scene change point to agree with to the boundary of GOP by using the list in the compression coding following easily correcting scene change points of the image data and creating a correct the scene change point list, which can contribute to improve the quality of the image after the compression coding and the efficiency of the compression coding.

A method of creating the scene change point information list by detecting scene change points from the image data will be explained.

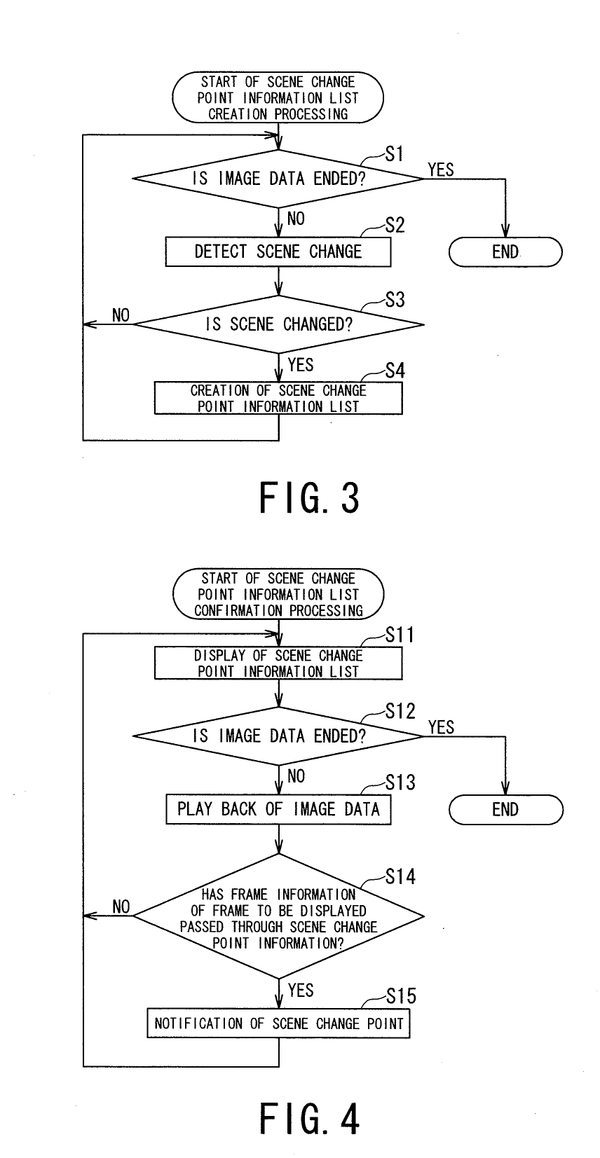

FIG. 3 is a flowchart of scene change point information list creation processing when the scene change point information list is created by detecting the scene change point from the image data in the image analysis apparatus 1.

As shown in FIG. 3, first, at step S1, the scene change detection unit 3 obtains the image data from the image data storage unit 2. The image data is sequentially input from the start frame of an image to the end frame thereof. The input operation is finished when the image data is input up to the end frame thereof. Herein, when the start point and the end point of a scene change point detecting operation are indicated from the scene change point detection start point input unit 27e and the scene change point detection end point input unit 27f of the basic information input unit 27, the image data is sequentially input from the start frame of the scene change point detecting operation to the end frame thereof. The input operation is finished when the processing progresses up to the end frame of the scene change point detecting operation.

At step S2, the scene change detection unit 3 analyzes the image data, which is input from the image data storage unit 2 at step Si, and detects a scene change point. Herein, as a method of detecting the scene change, there is known an example that the change of luminance (in an RGB format, luminance calculated from respective R, G, B component) between, for example, continuous frames or between adjacent frames is determined by statistical processing, and it is determined that the scene change occurs when the value of the change is larger than a threshold (refer to JP-A 07-111631 and JP-A 07-193818).

At step S3, when the scene change detection unit 3 detects the scene change point at step S2, the scene change detection unit 3 outputs scene change point information to the scene change information storage unit 4, and the controller 5 goes to step S4. When the scene change detection unit 3 does not detect the scene change point, the controller 5 returns to step S1 and repeatedly executes the processing at step S1 and subsequent steps.

At step S4, the scene change point information, which is output by the scene change detection unit 3 at step S2, is stored in the scene change information storage unit 4 in a predetermined data format, and the controller 5 returns to step S1. Thereafter, the processing at step S1 and subsequent steps are repeatedly executed.

With this operation, the image data progresses from the start frame to the end frame, scene change points are detected, the scene change point information is sequentially and additionally stored each time the scene change detection unit 3 outputs the scene change point information, thereby the scene change point information list is created.

As shown in, for example, table 1, the scene change point list of the image data stored in the image data storage unit 2 is created. The scene change point list is information in which the frame information and the time code information can be converted to each other by the origin from the basic information input unit 27, the time code of the scene change start point/end point, and the frame rate information.

### Table 1

Next, a method of confirming scene change points using the scene change point information list obtained by detecting the scene change of the image data will be explained.

FIG. 4 is a flowchart of scene change point information list confirmation processing when the scene change point is confirmed using the scene change point information list obtained by detecting the scene change of the image data in the image analysis apparatus 1.

As shown in FIG. 4, first, at step S11, the scene change point information list conversion unit 8 converts all the scene change point information stored in the scene change information storage unit 4 as the frame information to the time code information, creates the scene change point information list, and displays it on the display unit 10.

At step S12, the image data playback unit 6 receives the frame information of frame in the image data to be played back on the display unit 10 from the controller 5 and obtains the frame from the image data storage unit 2. The image data is sequentially obtained from the start frame of the image data to the end frame thereof at arbitrary frame intervals. The above processing is finished when the image data progresses to the end frame. Herein, when the start point and the end point of the scene change point detecting operation are indicated from the scene change point detection start point input unit 27e and the scene change point detection end point input unit 27f of the basic information input unit 27, the image data is sequentially input from the start frame of the scene change point detecting operation to the end frame thereof. The above processing is finished when the input operation progresses up to the end frame of the scene change point detecting operation.

At step S13, the image data playback unit 6 plays back frames in the image data obtained from the image data storage unit 2 at step S12. The display unit 10 displays the played back frame.

At step S14, the controller 5 monitors the frame information of a frame in the image data to be played back on the display unit 10 at step S13 and determines whether or not the information of the frame has passed through scene change points included in all the scene change point information stored in the scene change information storage unit 4. When the frame information of a frame in the image data to be played back on the display unit 10 has passed through a scene change point included in all the scene change point information stored in the scene change information storage unit 4, the controller 5 goes to step S15. Otherwise, the controller 5 returns to step S11 and repeatedly executes the processing at step S11 and subsequent steps.

At step S15, the controller 5 emphatically displays the scene change point information, through which the frame information of a frame in the image data to be played back on the display unit 10 passes, that is, the scene change point information when playback frame number≧scene change frame number on the scene change point information list display unit 35 provided with the display unit 10. Further, the controller 5 notifies occurrence of the scene change point by the scene change point notification information unit 32. At the same time, the controller 5 can also output a scene change point notification sound (audio signal) from the audio output unit 11. Thereafter, the controller 5 returns to step 11 and repeatedly executes the processing at step S11 and subsequent steps.

With this operation, each time the image data being played back progresses from the start frame to the end frame and has passed through a scene change point, occurrence of a scene change point is notified to the operator.

Herein, each time the occurrence of a scene change point is notified in the scene change point information list confirmation processing shown in FIG. 4, the operator may appropriately edit the scene change point. The method will be explained below.

Next, a method of confirming the scene change point using the scene change point information list and editing the scene change point information will be explained.

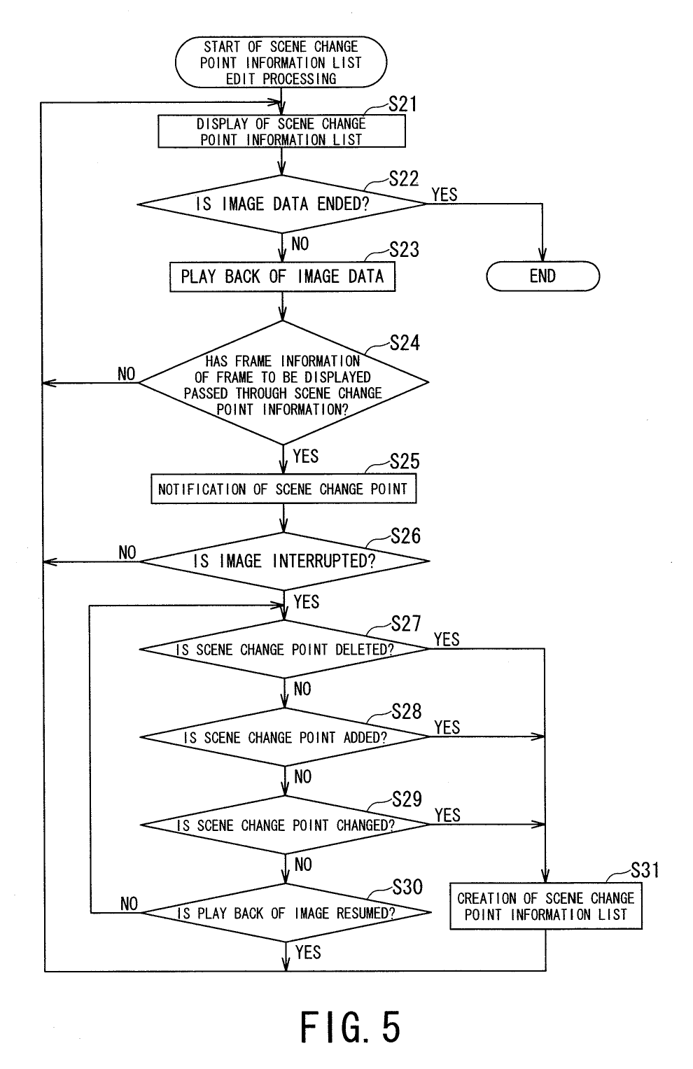

FIG. 5 is a flowchart of scene change point information list edit processing when the scene change point is edited using the scene change point information list obtained by detecting the scene change of the image data in the image analysis apparatus 1.

Since processing at steps S21 to S24 of FIG. 5 is the same as the processing at steps S11 to S14 of FIG. 4, the explanation thereof is omitted to avoid repeated explanation.

As shown in FIG. 5, at step S25, the controller 5 emphatically displays the scene change point information, through which the frame information of a frame in the image data to be played back on the display unit 10 passes, that is, the scene change point information when playback frame number≧scene change frame number on the scene change point information list display unit 35 provided with the display unit 10. Further, at the same time, the controller 5 can also output a scene change point notification sound from the audio output unit 11.

When the operator inputs operation information from the pause operation unit 23c of the image operation unit 23 at step S26, the controller 5 pauses the image being played back on the display unit 10 while displaying the frame being displayed. Otherwise, the controller 5 returns to step S21 and repeatedly executes the processing at step S21 and subsequent steps. A main object of the pause is to confirm whether or not scene change detection is correctly performed by confirming the frame and the preceding and succeeding frames thereof. When it can be confirmed that a scene change is correctly performed while it is being played back, the image can be continuously played back without pause.

When the operator inputs operation information from the delete operation unit 26c of the scene change point operation unit 26 at step S27, the controller 5 outputs information for deleting the scene change point information of the scene including the frame, which is being displayed, of the image paused at step S26 to the scene change information storage unit 4, and the controller 5 goes to step S31. Otherwise, the controller 5 goes to step S28.

When the operator inputs operation information from the addition operation unit 26a of the scene change point operation unit 26 at step S28, the controller 5 outputs the information for adding the frame information of the frame, which is being displayed, of the image paused at step S26 to the scene change information storage unit 4 as the scene change point information, and the controller 5 goes to step S31. Otherwise, the controller 5 goes to step S29.

Note that a desired frame can be selected as the frame, which is being displayed, of the image paused at step S26 by operating the preceding scene jump operation unit 23d, the succeeding scene jump operation unit 23e, the jump frame number input unit 23a, the preceding frames jump operation unit 23f, the succeeding frames jump operation unit 23g, the preceding frame jump operation unit 23h, and the succeeding frame jump operation unit 23i of the image operation unit 23.

Further, the scene change point information to be added at step 28 can be selected by inputting desired time code information to the time code information input unit 24 of the scene change point operation unit 26.

When the operator inputs operation information from the change operation unit 26b of the change operation unit 26 at step S29, the controller 5 outputs information for changing the scene change point information of the scene including the frame, which is being displayed, of the image paused at step S26 to the scene change information storage unit 4, and the controller 5 goes to step S31. Otherwise, the controller 5 goes to step S30.

When the operator inputs operation information from the playback operation unit 23b of the image operation unit 23 at step S30, the controller 5 returns to step S21 and resumes playback from the paused image at step S25. Otherwise, the controller 5 returns to step S27 and repeatedly executes the processing at step S27 and subsequent steps.

At step S31, the scene change information storage unit 4 stores the scene change point information output at least one of step S27 to step S29 in a predetermined data format and creates the scene change point information list, and then the controller 5 returns to step S21. Thereafter, the controller 5 repeatedly executes the processing at step S21 and subsequent steps.

An example, in which the scene change point is confirmed using the scene change point information list and the scene change point information list is edited, will be explained.

As shown in FIG. 2, the screen 40 displays the information stored location indicating unit 21, the scene change detection execution unit 22, the image operation unit 23, the time code information input unit 24, the scene change point information selection unit 25, the scene change point operation unit 26, and the basic information input unit 27.

Further, as shown in FIG. 2, the screen 40 displays the scene change detection progress display unit 31, the scene change point notification information unit 32, the time code information display unit 33, the image playback display unit 34, and the scene change point information list display unit 35.

The operator detects scene change points from the image data. First, the operator stores the image data in the image data storage unit 2. The operator indicates the image data by the image data file stored location indicating unit 21a of the information stored location indicating unit 21. Further, the operator indicates the scene change information list on the scene change information storage unit 4 in which scene change points detected from the image data are stored, by the scene change information list stored location indicating unit 21b of the information stored location indicating unit 21. Next, the operator starts to detect scene change points of the image data by operating the scene change detection start unit 22a of the scene change detection execution unit 22. When the operator stops to detect scene change points of the image data while they are being detected, the operator stops to detect scene change points of the image data by operating the scene change detect cancellation unit 22b of the scene change detection execution unit 22. The scene change detection unit 3 detects scene change points and stores the scene change point information in the scene change information storage unit 4. At the time, the progress of scene change points detection is displayed on the scene change detection progress display unit 31 (detecting operation of scene change point).

Next, the operator starts to play back the image data by operating the image operation unit 23. At the time, the scene change point information list display unit 35 displays all the scene change points stored in the scene change information storage unit 4. When the image data includes a plurality of scenes, scene change points are displayed as a list. When the operator indicates an arbitrary jump frame number N to the jump frame number input unit 23a of the image operation unit 23 and operates the playback operation unit 23b of the image operation unit 23, the operator can arrange the image displayed on the image playback display unit 34 as a image played back every N frames. When the frame in the image displayed on the image playback display unit 34 has passed through a scene change point, the frame information/scene change point information comparison/determination unit 15 outputs notification information to the scene change point notification information unit 32. Further, the frame information/scene change point information comparison/determination unit 15 can also cause the audio output unit 11 to output a scene change point notification sound. With this operation, the operator can prevent to miss scene change points (scene change point confirmation support operation) by visually comparing the informations located in two different display positions, that is, the image being played back in the image playback display unit 34 and the scene change point information of the scene change point information list display unit 35.

Next, the operator searches an optimum scene change point. The operator pauses the images being played back on the image playback display unit 34 in a state that an arbitrary frame is displayed on the image playback display unit 34 by operating the image operation unit 23 and operates the scene change point operation unit 26.

When, for example, the preceding scene jump operation unit 23d or the succeeding scene jump operation unit 23e of the image operation unit 23 is operated, the frame in the image data, which is played back on the image playback display unit 34, jumps to a just preceding or succeeding scene change point. When, for example, the preceding frames jump operation unit 23f or the succeeding frames jump operation unit 23g is operated, the frame in the image data, which is played back on the image playback display unit 34, jumps to the preceding or succeeding frame by the number of frames input to the jump frame number input unit 23a. Further, when the preceding frame jump operation unit 23h or the succeeding frame jump operation unit 23i is operated, the frame in the image data, which is played back on the image playback display unit 34, jumps to the preceding or succeeding frame of the above frame by one frame. When the frame in the image data displayed on the image playback display unit 34 is a frame desired as a scene change point, the playback of the image is paused by operating the pause operation unit 23c. At the time, the time code information display unit 33 displays a time code information corresponding to the frame in the image data being displayed on the image playback display unit 34. When the paused frame is located behind a scene change point, it can be corrected by a image operation unit 23. In particular, it may be difficult to stop a target frame when it is paused, and thus the frame may be passed. In this case, the image operation unit 23 is effective.

Further, when the playback of the image is paused, the time code information input unit 24 and the scene change point information selection unit 25 are placed in an operation input receivable state. When the desired time code information is input to the time code information input unit 24, the frame in the image data displayed on the image playback display unit 34 can be changed to the desired frame. When a desired scene change point is selected from the scene change point information list displayed by the scene change point information selection unit 25, the frame in the image data displayed on the image playback display unit 34 can be changed to a frame corresponding to the desired scene change point.

Next, when a paused arbitrary frame is a desired frame as a scene change point, the information, which adds the scene change point information of the paused arbitrary frame, is output to the scene change point information list edit unit 7 by operating the addition operation unit 26a of the scene change point operation unit 26. When a scene change point of the scene including the paused arbitrary frame is an unnecessary scene change point, the information, which deletes the scene change point information of the scene including the paused arbitrary frame, is output to the scene change point information list edit unit 7 by operating the delete operation unit 26c. Further, when it is desired to change the scene change point information of the scene including the paused arbitrary frame, the information, which changes the scene change point information of the scene including the paused arbitrary frame, is output to the scene change point information list edit unit 7 by operating the change operation unit 26b and a time code information input unit 24.

Edited scene change point information is sent from the scene change point information list edit unit 7 to the scene change information storage unit 4 by the edit operation of the scene change point and stored therein (edit operation of scene change point).

According to the image analysis method of the embodiment, a scene change point can easily compared with an image prior to the compression coding of image data. Further, an editing work such as addition of desired scene change points, deletion of unnecessary scene change points, and change of existing scene change points, and the like can be performed easily and simply while easily comparing the scene change point with the image.

Specifically, in conventional scene change detection methods as described above, when a scene change point is erroneously detected (1) at the time an image in a frame has a large amount of changes as in a shooting and bombing scenes, (2) at the time a same frame continues in slow motion processing after an image has been shooted, and (3) at the time a parameter such as luminance and the like for measuring the amount of image change changes little, the operator can easily find erroneously detected unnecessary scene change points. Further, the operator can easily perform an edit operation such as deletion of erroneously detected unnecessary scene change points.

That is, it is possible to cause the scene change point to agree with the boundary of GOP by creating the correct scene change point list by easily correcting the scene change point list of the image data and using the list in the compression coding, which contributes to improve the quality of the image after the compression coding and to improve the efficiency of the compression coding.

A series of processing explained in the embodiment can be executed by hardware although it can be executed by software.

Further, although the embodiment of the present invention explains the example, in which the processing is executed time-sequentially along the described sequence at the respective steps of the flowchart, the processing is not necessarily executed time-sequentially, and the embodiment also includes a case in which the processing is executed in parallel or individually.

What is claimed is:

1. An image analysis apparatus comprising:
a storage module configured to store scene change points comprised in image data as a scene change point information list;
a display module configured to display frames based on the image data and the scene change point information list;
a determination module configured to determine whether or not a frame in the image data displayed on the display module corresponds with a scene change point, when the image data is played back; and
a notification module configured to notify that a scene change occurred on the display module when the determination module determines that the displayed frame corresponds with the scene change point.

2. The image analysis apparatus of claim 1, wherein the notification module is configured to notify that the displayed frame corresponds with the scene change point comprised in the scene change point information list by causing the display module to display a notification.

3. The image analysis apparatus of claim 1 further comprising an audio output module configured to output an audio signal, wherein the notification module is configured to notify that the displayed frame corresponds with the scene change point comprised in the scene change point information list by causing the audio output module to output the audio signal.

4. The image analysis apparatus of claim 2 further comprising an audio output module adapted to output an audio signal, wherein the notification module is configured to notify that the displayed frame corresponds with the scene change point comprised in the scene change point information list by causing the audio output module to output the audio signal.

5. The image analysis apparatus of claim 1 further comprising:
an operation input module configured to input an operation of editing, comprising at least one of adding, deleting and changing a scene change point for editing the scene change point information list displayed on the display unit; and
an editing module configured to edit the scene change point information list based on the operation inputting from the operation input module.

6. The image analysis apparatus of claim 2 further comprising:
an operation input module configured to input an operation comprising at least one of adding, deleting and changing a scene change point for editing the scene change point information list; and
an editing module configured to edit the scene change point information list based on the operation inputting from the operation input module.

7. The image analysis apparatus of claim 3 further comprising:
an operation input module configured to input an operation comprising at least one of adding, deleting and changing a scene change point for editing the scene change point information list; and
an editing module configured to edit the scene change point information list based on the operation inputting from the operation input module.

8. The image analysis apparatus of claim 4 further comprising:
an operation input module configured to input an operation comprising at least one of adding, deleting and changing a scene change point for editing the scene change point information list; and
an editing module configured to edit the scene change point information list based on the operation inputting from the operation input module.

9. An image analysis method of detecting a scene change in image data comprising frames and creating a list of scene change point information for the image data, the method comprising:
playing back the image data to display frames for detecting a scene change;
determining whether or not the displayed frame corresponds with a scene change point comprised in the scene change point information list; and
notifying that a scene change occurred when the displayed frame corresponds with the scene change point.

10. The image analysis method of claim 9, wherein the notification of occurrence of the scene change is performed by displaying a signal.

11. The image analysis method of claim 9 wherein the notification of occurrence of the scene change is performed by outputting a notification sound.

12. The image analysis method of claim 10 wherein the notification of occurrence of the scene change is performed by outputting a notification sound.
